(19) United States
(12) Patent Application Publication
(10) Pub. No.: US 2007/0040115 A1
(43) Pub. Date: Feb. 22, 2007

(54) Method for calibrating particle beam energy

(76) Inventors: Julia G. Publicover, Toronto (CA); Suzanne E. Lapi, Burnaby (CA); Thomas J. Ruth, Vancouver (CA)

Correspondence Address: HARNESS, DICKEY & PIERCE, P.L.C., P.O. BOX 8910, RESTON, VA, 20195, US

(21) Appl. No.: 11/499,681

(22) Filed: Aug. 7, 2006

Related U.S. Application Data
(60) Provisional application No. 60/705,480, filed on Aug. 5, 2005.
(60) Provisional application No. 60/785,378, filed on Mar. 24, 2006.

(51) Int. Cl. H01J 47/00

(52) U.S. Cl. 250/305

(57) ABSTRACT

Disclosed are methods for determining the energy of a particle beam, for example a proton beam, by measuring the ratio of the radioactivities associated with two radioisotopes that are simultaneously produced within a plurality of target foils versus the calculated beam energy drop through each individual foil. This method relies on the disparate production of related radioisotopes in a single material as a function of the beam energy. A calibration curve may be established by irradiating target metal foils of known thickness and measuring the relative radioactivities of at least two target radioisotopes resulting from that irradiation. In particular, the method can be used to determine beam energies in the 10 to 18 MeV range by measuring the relative production of ⁶³Zn and ⁶⁵Zn in natural Cu foils.

### PRIORITY STATEMENT

This application claims priority under 35 U.S.C. 119 from U.S. Patent Application Nos. 60/705,480, filed Aug. 5, 2005, and 60/785,378, filed Mar. 24, 2006, the contents of which are incorporated herein, in their entirety, by reference.

### BACKGROUND

Positron emission tomography (PET) is a non-invasive medical imaging technique, which makes use of positron emitting radionuclides as biological indicators. When a positron is emitted through the decay of a radionuclide it will lose energy through interactions with electrons along its path. At the end of its range each positron will annihilate with an electron and give rise to two photons, which are released simultaneously at nearly 180 degrees to one another.

By placing an appropriate array of detectors around the radioactive isotope, these coincident photons can be detected and the line of response (LOR) between them can be found. To create a line of response, the two coincidence photons must arrive in opposing detectors within a predefined time of one another, typically a few nanoseconds. If one of the coincidence photons is not detected within this time limit the event is rejected. These lines of response can then be used to mathematically back-calculate the location of the annihilating positron and hence obtain a density map of radioactivity. This is illustrated in FIG. 1 in which annihilation events produce a series of photon pairs that are, in turn, detected by the surrounding detector elements. The first line of response indicates that somewhere along this line positron annihilation has taken place. Each consecutive line will then determine the specific location in space by their intersection with one another. This density map can then be used to recreate image slices.

The basis of PET is that if a positron-emitting isotope is attached to a biologically important compound (radiopharmaceutical), we can then obtain the spatial and temporal distribution of that compound within an organ or biological system. TABLE 1 lists several of the most common radiopharmaceuticals, along with their production route, half-lives (t_{1/2}), and applications.

TABLE 1

| | Nuclear | t_{1/2} | Radio- | |
|---|---|---|---|---|
| Isotope | Reaction | (minutes) | pharmaceuticals | Application |
| ¹¹C | ¹⁴N(p,α)¹¹C | 20.4 | Raclopride | D2 receptor |
| | | | | density |
| | | | Methylphenidate | Dopamine |
| | | | | transporter |
| ¹⁸F | ¹⁸O(p,n)¹⁸F | 109.8 | Fluorodeoxyglucose | Glucose |
| | ²⁰Ne(d,α)¹⁸F | | | Utilization |
| | | | Fluorodopa | Decar- |
| | | | | boxylation |
| | | | | and storage of |
| | | | | dopamine |
| ¹⁵O | ¹⁵N(p,n)¹⁵O | 2.03 | O₂ | Oxygen |
| | ¹⁴N(d,n)¹⁵O | | | Metabolism |
| | | | Water | Blood Flow |
| | | | Carbon monoxide | Blood Volume |
| ¹³N | ¹⁶O(p,α)¹³N | 9.97 | Ammonia | Cardiac Blood |
| | | | | Flow |

The true power of PET lies in the ability to acquire quantitative functional images at extremely high sensitivity. This ability is related to the intrinsic nature of the positron decay and being able to correct for attenuation, something not easily done with SPECT (single photon emission computed tomography), and its sensitivity, on the order of picomolar (pM) concentrations, is several orders of magnitude more sensitive than MRI (magnetic resonance imaging), which achieves millimolar (mM) concentrations.

PET produces “functional images.”. With most classical diagnostic tools images of structures (e.g., bones, organs, etc.) may be obtained; however, with PET one can image biological systems in action (e.g., uptake of compounds). This is illustrated in FIG. 2 which illustrates a PET image corresponding to the uptake of Fluorine-18 (¹⁸F) Fluorodopa within the striatum of the brain of a human subject suffering from Parkinson's disease. Fluorodopa is used to measure the decarboxylation and storage of dopamine.

The amount of attenuation caused by the surrounding material (i.e., the patient's tissues) can be determined by comparing the detector count rate with an external PET source (i.e., ⁶⁸Ge/⁶⁸Ga), without any attenuating material present, to the count rate with the attenuating material present. The attenuation coefficient for the two γ-rays may be determined using Formula 1:
e^{-μ}^{₁}^{x}^{₁}·e^{-μ}^{₂}^{x}^{₂}=e^{-μ(x}^{₁}^{+x}^{₂}⁾ [1]
wherein x₁ and x₂ are the distances from the source to the detector and μ₁ and μ₂ are the attenuation coefficients for air and the object, respectively. This allows the reconstructed image to be corrected for attenuation effects.

Around the world PET imaging is becoming more widely available for clinical diagnostics. The production of short-lived radiopharmaceuticals may, however, be quite costly. While many research groups have focused on increasing radioisotope yield while reducing the cost of production, additional information is needed for improving these processes further.

The production of radioisotopes for nuclear medicine is generally accomplished in one of three ways: 1) by neutron reactions in a nuclear reactor, 2) by decay and separation in a generator or 3) by charged particle bombardment via a particle accelerator, usually a cyclotron. The use of cyclotrons for the production of radioisotopes for PET is by far the most common production route used today.

The TR13 cyclotron, located in the Meson Hall, at TRIUMF, Canada's National Laboratory for Nuclear and Particle Physics, in Vancouver, Canada, is a fixed energy (13 MeV), proton only, negative ion (H⁻) machine. H⁻ ions are accelerated with the aid of radio-frequency (RF) energy and directed in a circular motion by a constant magnetic field. The RF is passed between metal plates called Dees. The proton beam is extracted by stripping both electrons off the H⁻ ion through a thin carbon foil. The removal of electrons not only provides the proton beam, but also changes the charge of the particle from negative to positive. Hence, the direction of motion within the magnetic field will be reversed. This allows the protons to be directed out of the cyclotron's vacuum tank and strike the production target. The TR13 is equipped with two extraction foils allowing for the production of two simultaneous beams.

Radioisotopes are produced through nuclear reactions by irradiation of a material with these accelerated particles. The vessel containing the material, as well as the material to be irradiated, is commonly referred to as the target. Target materials can be solids, liquids or gases. Solid targets, however, are rarely used in the production of PET isotopes due to the difficulty of separating the desired isotope from the target material. This process can be incredibly time consuming, which is a severe drawback when dealing with short-lived radioisotopes.

Gas targets are the most commonly used form of target for PET radioisotopes. They have certain advantages over the other types of targets including:
i. A relatively simple target chamber design because melting and boiling is not an issue.
ii. Gas transfer from the target to the laboratory is fast, clean and simple. Speed is imperative when dealing with isotopes with half-lives on the order of minutes.
iii. The separation of the radioisotope from the bulk target gas is uncomplicated. Separation is accomplished by making use of the differences in physical and/or chemical properties of the target gas and product.

Gas targets, however, suffer from density reduction in the gas due to heat being deposited by the beam of charged particles. This results in a much lower production yield as compared to the theoretical values based on available cross-section data. As reported in Bida et al.'s “Experimentally determined thick target yields for the ¹⁴N(p,α)¹¹C reaction,” Radiochimica Acta, 27(1980) 181, Bida, Ruth and Wolf determined that the production of Carbon-11 from the (p,α) reaction on Nitrogen gas is approximately 25% less than the yield calculated from published excitation functions and speculated that this was due to gas density reduction within the target gas. Gas density reduction is discussed in more detail below.

It has also been reported that wall interactions may contribute to lower yields than predicted. It was found that the produced radionuclide may interact with the walls of the target chamber and stick, thus reducing the recoverable yield. Multiple coulomb scattering can also reduce the production yield. The angular spread of a particle beam may become great enough that a substantial number of particles are eliminated from the production process by interacting with the target chamber walls.

Explanation and rectification of these issues with gas targets could benefit a large cross-section of fields of research. For example, within nuclear medicine alone these targets are used to produce Iodine-123 for SPECT (Single Photon Emission Computed Tomography), many isotopes for PET as noted above (¹¹C, ¹⁵O, ¹⁸F), as well as for other less common isotopes such as Rubidium-82. There has also been great interest in gas targets for nuclear physics, particularly in recent studies for radioactive ion beams used in nuclear physics and astrophysics experiments.

Protons, as well as any charged particle whose rest mass greatly exceeds the rest mass of an electron, lose most of their kinetic energy through Coulomb interactions (inelastic collisions) with atomic electrons. This results in both ionization and excitation of the atoms in the absorber. The original approach to evaluate this energy loss, developed by Niels Bohr in 1913, was dependent on the impact parameter between the particle's trajectory and the target nucleus. However, with the advent of quantum mechanics, we must now consider that a particle with a well defined momentum cannot also have a well defined position. Thus, the approach most commonly used today, as developed by Hans Bethe in 1930, depends on the momentum transfer from the particle to the target electrons.

For this project we have employed a Monte Carlo based program, the Stopping and Range of Ions in Matter (SRIM), to model a proton beam incident on an Argon gas target. An overview of the theory behind the stopping of heavy charged particles in matter is provided below.

The mean rate of this energy loss by ionization, also know as stopping power or specific ionization, can be approximated by the Bethe-Bloch equation:

$$- \frac{ⅆ E}{ⅆ x} = \frac{4 {πⅇ}^{4} {Z}_{2} {Z}_{1}^{2} N}{{m}_{e} {v}^{2}} [ ln \frac{2 {m}_{e} {v}^{2}}{〈 I 〉} - ln ( 1 - {β}^{2} ) - {β}^{2} - \frac{C}{{Z}_{2}} - \frac{δ}{2} ]$$

in which the variables are those defined below in TABLE 2.

TABLE 2

| Variable | Definition | Value |
|---|---|---|
| e | Elementary charge | 1.602 × 10⁻¹⁹ C |
| Z₁ | Particle atomic number | e.g., proton Z₁ = 1 |
| Z₂ | Target atomic number | e.g., carbon Z₂ = 6 |
| mₑ | Electron rest mass | 5.11 × 10⁵ eV |
| v | Particle velocity | Units given in meters |
| | | per second. |
| I | Mean ionization energy of | Usually regarded as an empirical |
| | the atomic electrons | constant. |
| C/Z₂ | Shell Correction term | Experimentally determined. |
| | | Only valid for particles with |
| | | Z₁ = 1. |
| δ/2 | Density effect correction to | Usually equal to zero for gases |
| | ionization energy loss | [12]. |
| β | Relativistic particle velocity | Equal to v/c, were v is the |
| | | incident particle velocity. |
| N | Atomic density of the target | Units given in atoms per cm³. |

A graph of the mass stopping power versus incident particle energy can be found in FIG. 5. Linear stopping power is defined as the rate of energy loss per unit path length (MeV/cm), while the mass stopping power is this linear stopping power divided by the density of the absorbing material and is given in MeV/mg/cm^{2 .} The values were determined using a Stopping Range In Matter (SRIM) computer program which incorporates the assumption that the incident particle only interacts with the target through electromagnetic forces. All energy loss due to nuclear reactions is assumed to be negligible. It has been shown that less than 0.1% of the energy loss of high velocity particles can be attributed to the interactions with target nuclei.

The shell correction term, C/Z₂, compensates for the lack of participation of the inner shell electrons with the slowing down of the incident particle. The mean ionization term, ln<I>, is the mean ionization potential needed to ionize the target atom electrons. The density effect term, δ/2, corrects for polarization, which may occur in the target. As a proton passes through a target it can interact with many atoms at once and polarization of the target atoms along its path can occur thus reducing energy lost by the proton. This effect is dependent on the target density. Since the inter-atomic spacing in a gas is much larger than a solid or liquid the incident proton can only interact with one target atom at a time and the density effect term is assumed to be zero.

The total range of a particle, whose only mode of energy loss is through ionization and excitation of atomic electrons, can be found through the integration of the Bethe-Bloch equation above. This is known as the “continuous slowing down approximation” (CSDA). From this it follows that the range of a charged particle is affected by the following: the atomic number and mass of the target material, as well as the energy, mass and charge of the impinging charged particle.

As mentioned above, the primary mode of energy loss between an incident heavy charged particle (m>>mₑ) and the target material is through Coulomb interactions with the atomic electrons. A particle can interact with thousands of electrons along its track. This results in many small angle scatters and is known as multiple Coulomb scattering (or simply multiple scattering). Multiple scattering of the beam plays an important role in the design of gas target chambers. In a typical PET target body, a particle beam will pass through two thin foil windows, separated by helium cooling gas, prior to entering the target gas itself. Both foils as well as the gas will increase the angular spread of the beam and hence the location of deposited energy. In order to minimize loss of beam to the target body walls, many targets include a gas chamber having a tapered profile, for example, a conical or frustoconical configuration, to accommodate for this expansion in beam diameter.

The theory behind multiple scattering is very complex and there have been many attempts to explain and simplify it. The theory most commonly used today, was developed by Molière and uses small angle approximations to solve the general problem. To use this approach in a Monte Carlo simulation, however, would require a large amount of computational time and power. The SRIM Monte Carlo program makes use of a method developed by Ziegler, Biersack and Littmark (ZBL) as a simplification to this problem. The ZBL approximation makes use of Molière potentials and an analytic formula, referred to as the “Magic Formula” to determine the scattering angles.

Gas targets are used extensively in the production of short-lived radioisotopes for radiopharmaceuticals due to their relatively simple design and the ease and speed with which the radioactivity can be transferred to the lab for processing. Gas targets, however, suffer from density reduction as the gas is heated by the particle beam which, in turn, has resulted in increased particle penetration as well as a significant pressure increases as beam current is increased. For example, during a typical production run of Carbon-11 from Nitrogen gas, the initial gas pressure, prior to introducing the proton beam, is around 2172 kPa (315 psi). During bombardment with a 20 μA proton beam this pressure will then rise to approximately 2910 kPa (422 psi). Density reduction depresses the radionuclide yield by moving gas molecules out of the beam strike region as a result of these pressure/temperature increases.

Heselius et al. studied this phenomenon by direct photography of the light emitted by target atoms during their bombardment with an intense ion beam. FIG. 6 shows a 5.9 MeV deuteron beam incident on 960 kPa of Neon gas at 12 μA. From the photograph reproduced in FIG. 6 we see an asymmetry in the beam shape. The bulge at the lower edge of the beam represents the theoretical range of the particles, however at this beam current the upper edge of the beam reaches substantially further into the gas due to a reduction in gas density in this area. This asymmetry has been attributed to the upward thermal transport of the gas by heat deposited by the beam.

Although many research studies have examined the issue of density reduction, it remains difficult to operate with high beam currents and achieve near theoretical yields. Some of these studies have included:
i. Interferometric readings of the gas density as a function of beam current. The refractive indices found were then used to calculate the average temperature within the target.
ii. Particle penetration studies were performed via current produced across an electrically isolated exit window and beam stop placed at the end of a target. The increase in particle penetration into the gas causes an increase in current reading as more charged particles penetrate the exit window.
iii. The pressure increase with increased beam current was also studied. The pressure-current relationship can be given by the following equation, P=P₀(aI^{b}+1), found by Wojciechowski et al. Here, P₀ and P are the initial and beam-on pressures respectively and “a” and “b” are regression constants. Using this, along with the ideal gas law, the change in gas temperature was estimated at ΔT=T₀(P/P₀−1).

Conventional methods for determining particle beam energy generally require sophisticated equipment and operational conditions that are frequently dissimilar to the conditions under which the cyclotron would actually be used. As a result of these difficulties and limitations, reliable energy measurements are not generally available for the operational energy ranges. Accordingly, there remains a need for a simple, reproducible procedure for evaluating the operational beam energies achieved or maintained for producing radioisotopes.

### SUMMARY

Example embodiments of methods for determining the energy of a particle beam, for example a proton beam, include creating a calibration curve corresponding to a ratio of the radioactivities of two radioisotopes that are simultaneously produced within a stack of target foils versus the calculated beam energy drop through each individual foil. The production of radioisotopes, as discussed below, changes as a function of energy. This calibration curve may be established by irradiating a stack of target metal foils, for example copper foils, of known thickness, for example 0.025 mm, and measuring the relative radioactivities of at least two target isotopes produced by irradiation of the target foils, for example, Zinc-63 and Zinc-65 resulting from a 13 MeV irradiation of natural Copper foils.

By lining the inner chamber of a gas target with corresponding target foils and measuring the ratio of radioactivities produced after bombardment with the particle beam, we have been able to determine the energy of the scattered particles using the previously generated calibration curve. Accordingly, the invention provides a relatively simple, inexpensive and accurate method for making such energy measurements under normal operating conditions. Indeed, current scattering methods can only be used at very low beam intensity and are so complicated that they are often not performed at all when new cyclotrons are commissioned and are wholly impractical for applied uses, for example the production of radioisotopes for medical imaging.

For example, in the production of radioisotopes for biomedical applications using a proton beam irradiation, the proton beam energy will determine the type and ratio of isotopes produced. A simple and accurate method for determining proton beam intensity allows for the production of the desired isotopes while minimizing the creation of undesired and possibly hazardous isotopes, thereby allowing for more efficient and effective radioisotope production. As detailed below, one feature of this method is the utilization of a plurality of foils of an appropriate material or materials, a simple timing device, and a calibrated gamma-ray spectrometer or other suitable means for determining the particle energy.

The charged particles produced by accelerators are used for a variety of applications, including the commercial production of radioisotopes for biomedical purposes. Because the production cross sections are highly dependent on the energy of the beam, accurate measurement of the energy of the particle beam is very important. The calibration methods detailed herein could, for example, be widely used for measuring the beam energy from cyclotrons used to produce medical isotopes. Additionally, the hardware necessary for practicing the method is generally suitable for configuration and packaging as a kit, thereby allowing cyclotron operators to test their machines at commissioning and/or at regular intervals.

As will be appreciated by those skilled in the art, this method is not limited to proton beams generated by cyclotrons, but will be generally applicable with suitable modifications for the measurement and calibration of almost any charged particle beam. Therefore, this invention could be applied to variety of research and commercial applications. Examples of additional particle beams that could be evaluated using the disclosed methods include, for example, ⁴He (alpha particles), ³He, and deuterons.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The invention will become more apparent by describing in detail example embodiments thereof with reference to the attached drawings in which:

FIG. 1 illustrates an array of detectors around a subject containing a radioactive isotope that generates coincident photons during decay that can, in turn, be detected and the corresponding line of response (LOR) determined for mapping the location of the annihilation reaction;

FIG. 2 illustrates a PET image of the uptake of ¹⁸F Fluorodopa within the striatum of the brain of a human subject with Parkinson's disease for measuring the decarboxylation and storage of dopamine;

FIG. 3 illustrates a schematic diagram of the TR13 cyclotron;

FIG. 4 is a photograph of the interior of the vacuum chamber of the TR13 cyclotron;

FIG. 5 illustrates the stopping power for protons in Argon gas as a function of particle energy;

FIG. 6 is a photograph illustrating beam spreading of a 5.9 MeV deuteron beam at 12 μA into 960 kPa Neon gas;

FIG. 7 illustrates an excitation function for the production of ¹¹C from ¹⁴N;

FIG. 8 illustrates a decay scheme for ⁶⁵Zn wherein Eγ is the γ-ray energy and b is the branching ratio;

FIG. 9 is a calibration curve for ratios of ⁶²Zn and ⁶⁵Zn;

FIG. 10 is a graphical output from a SRIM program modeling H ions in Ar gas at 1551 kPa;

FIG. 11 is a schematic representation of the storage phosphor process;

FIG. 12 is a schematic drawing of the experimental gas target used in generating the data reported herein;

FIG. 13 is a schematic drawing of a target foil holder that may used in conjunction with the gas target;

FIG. 14 represents the gamma spectrum of an irradiated copper foil;

FIG. 15 is a log-log plot representing absolute efficiency versus energy;

FIG. 16 is a photograph of the experimental gas target in position for irradiation of the target contents;

FIG. 17 is a graph representing the results achieved from autoradiographic images of a copper foil lined gas target;

FIG. 18 are autoradiographic images of copper foil linings from the experimental gas target after irradiation at 1 μA, 10 μA and 20 μA respectively into argon gas at an initial pressure of 2068 kPa;

FIG. 19 is a calibration curve representing both actual and calculated ratios of the ⁶³Zn and ⁶⁵Zn isotopes; and

FIGS. 20A through 22C are graphs representing the results obtained at different beam currents and different gas pressures in the experimental gas target.

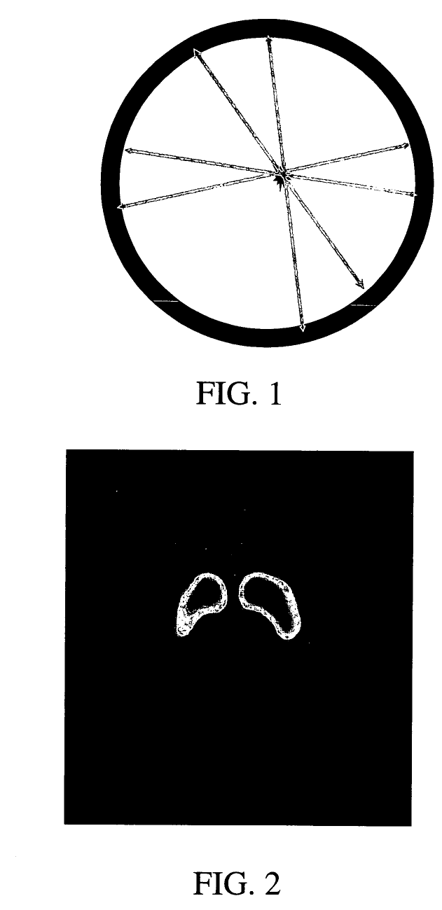

These drawings have been provided to assist in the understanding of the example embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity.

### DETAILED DESCRIPTION OF EXAMPLE EMBODIMENTS

The utility and accuracy of an example embodiment of the calibration methods disclosed herein has been established on the TR19 cyclotron at the Edmonton Cross Cancer Institute in Alberta using stacks of foils consisting of Cu (target foils) and Al (serving as spacers and catcher foils) positioned to receive beams of two different energies (i.e., arranged at two different extraction positions on the cyclotron). As will be appreciated by those skilled in the art, the procedure can be adapted for use with any accelerator by matching the energy regime to be calibrated with one or more appropriate target foil material(s), i.e., materials that will produce at least two different radioisotopes with differing excitation functions when irradiated within the expected energy regime. In most instances, the use of a device such as a high resolution Ge detector will improve the accuracy by quantitatively identifying the resulting isotopes. Alternative means of detecting the radiation can be used as long as the decay characteristics are unique, e.g. half-life. As will also be appreciated, the particular configuration of the foils and the foil holders can be adapted for a wide range of equipment.

As suggested above, the basic technique may be easily be adapted for various applications by the judicious selection of foil material(s) and the potential radionuclides thus generated by a charged particle beam. An array of foils (and associated nuclear reactions) can be provided for spanning a wide range of energies required for the accelerator of interest. For example, Copper and Molybdenum foils can span the following ranges using the indicated radioisotope ratios: 3 MeV to 6 MeV (^{63/65} Zn from Cu), 6-12 MeV (^{94/95m} Tc from Mo) and 13 to 18 MeV (^{62/65}Zn from Cu).

Further, this approach would not be limited to protons or cyclotrons and in fact could be extended to any type of particle accelerator. Although this technique may be somewhat less accurate than conventional scattering methods, this limitation would be relevant only with regard to high precision scientific measurements whereas for the vast majority of applications, the method presented herein would provide ample accuracy.

This invention provides a simple method for measuring the induced radioactivity. At this stage the foils need to be analyzed with a calibrated gamma detector to identify and quantify the induced radioactivity. Not all facilities would have calibrated gamma detectors. Thus, if a simple device could be used instead, such as an ionization chamber that exist in nearly all radioisotope production facilities, it would be easier and make the approach available to all. If the analysis of the foils could be adapted to allow the use of an ionization chamber, it would avoid the need for the gamma ray spectrometer.

Several common nuclear reactions for the production of PET isotopes can be found above in TABLE 1. The probability that any such a reaction will take place is dependent on the reaction cross-section, and hence incident particle energy, as well as the thickness of the target in nuclei per cm² and flux of incoming particles. The rate of production is given by Formula 2:

$$- \frac{ⅆ n}{ⅆ t} = R = nI ( 1 - {ⅇ}^{- λ t} ) {\int }_{{E}_{s}}^{{E}_{0}} \frac{σ ( E )}{ⅆ E / ⅆ x} ⅆ E \qquad [ 2 ]$$

wherein
R is the number of nuclei formed per second;
n is the target thickness in nuclei per cm²;
I is the incident particle flux per second and is related to beam current;
λ is the decay constant and is equal to ln2/t_{1/2};
t is the irradiation time in seconds;

$${\int }_{{E}_{s}}^{{E}_{0}}$$

is the integral from the initial to final energy of the incident particle along its path;
σ(E) is the reaction cross-section, or probability of interaction, expressed in cm²;
E is the energy of the incident particles; and
x is the distance traveled by the particle.

Because the thickness of the copper foils used in this example embodiment were relatively thin (0.025 mm), it was assumed that a linear change in cross-section was experienced in each foil, allowing use of an average cross-section for the energy drop through each foil. This reduces Formula 2 to the following Formula 3:
R=nIσ(1−e^{-λt}) [3].

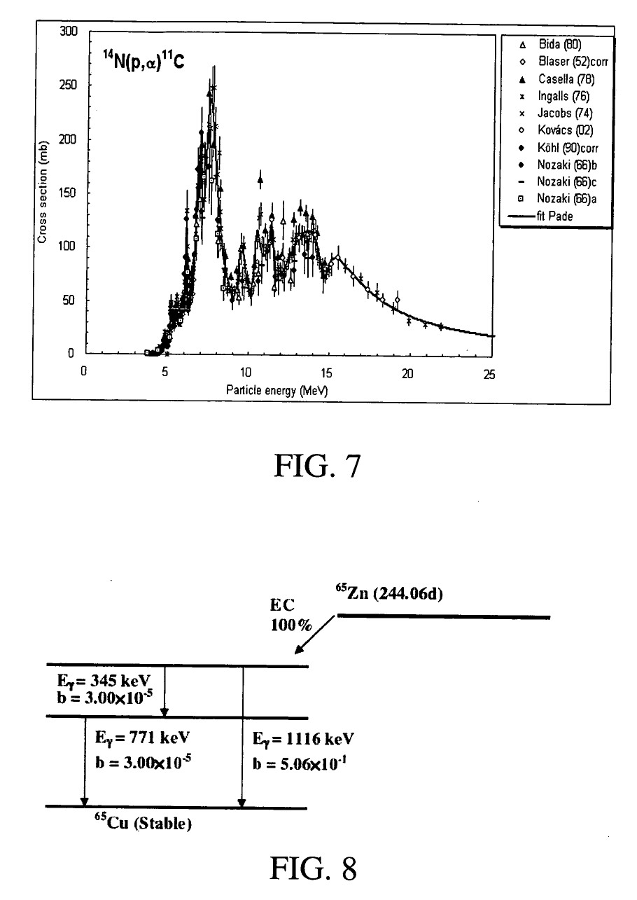

In our efforts to map the energy with which our proton beam interacts with a gas target body's walls, we produced radioactivity in metal foil linings. As mentioned above the amount of radioactivity produced is dependent on the cross-sections for the nuclear reaction in question. Cross-sections for nuclear reactions are highly dependent on the energy of the incident particle. This dependence is referred to as the “excitation function” of a particular reaction. As an example, the excitation function for the production of Carbon-11 from Nitrogen-14 can be found in FIG. 7. Classical theories on nuclear reaction cross-sections simply utilize the geometrical area of the target nucleus (πR²), so long as the incident particles energy was sufficiently large to overcome Coulombic repulsion. It follows that the units for a cross-section are those of area and are called barns, wherein 1 barn=10⁻²⁴ cm².

Most charged particle reactions are referred to as “threshold reactions” because the charged particle must have a minimum energy in order to overcome the Coulomb barrier of the nucleus it is impinging upon as well as reserve some of its energy to conserve the momentum of the system. Interactions below the threshold energy, however, do sometimes take place through quantum-mechanical tunneling. Considering FIG. 7, we can see that the threshold energy for the reaction (¹⁴N+p→¹¹C+α) is around 4 MeV.

Radioactive decay is a spontaneous, statistically random process whereby particles or electromagnetic radiation are emitted during a nuclear transition. During this process a radionuclide, called the parent, emits particles to form an entirely new isotope, called the daughter. The daughter may be either stable or radioactive. The most common modes of decay are through alpha, beta, including electron capture, and gamma emission. The rate with which a radioisotope will decay, measured in disintegrations per second, is simply the radioactivity given by as expressed in Formula 4:
A=A₀e^{-λt} [4]
wherein:
A is the radioactivity in disintegrations per second
A₀ is the initial radioactivity at t=0
λ is the decay constant and is equal to ln2/t_{1/2}, where t_{1/2} is the half-life of the isotope in seconds.
And t is the time the radioisotope has decayed, in seconds.

An isotope may decay by one or more decay modes. This is called branching decay. The transition from the parent to daughter isotope can be described using a “decay scheme.” FIG. 8 shows the decay of Zinc-65 to Copper-65 through electron capture, a form of beta decay: ⁶⁵Zn+e⁻→⁶⁵Cu*→⁶⁵Cu+γ. We see from this decay scheme that Zinc-65 decays to an excited state of Copper-65. Copper-65, in turn, emits photons during its transition to the ground state. These photons are emitted at known energies with known branching ratios. Therefore, when we observe spectra of these gamma emissions, which are discussed below, we are observing the photons emitted by Copper-65 as a result of the decay of Zinc-65.

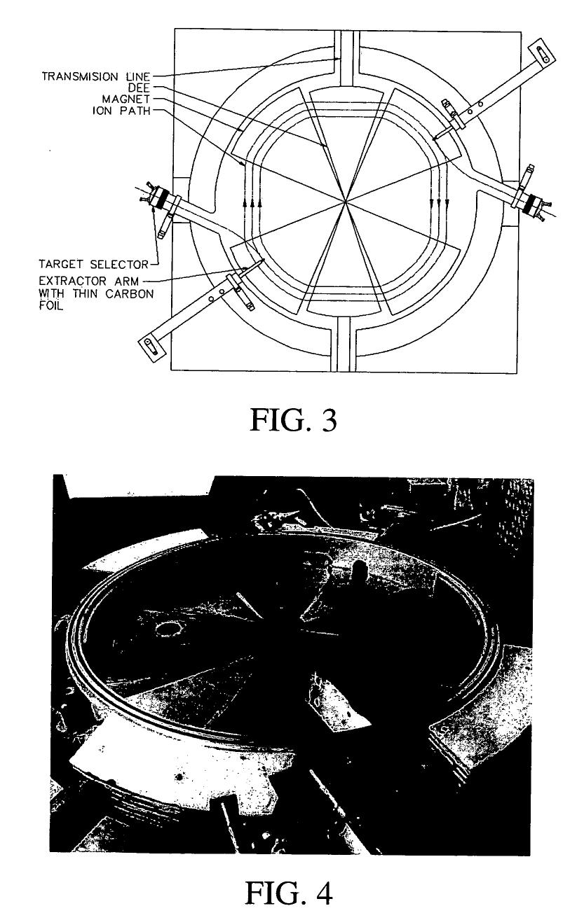

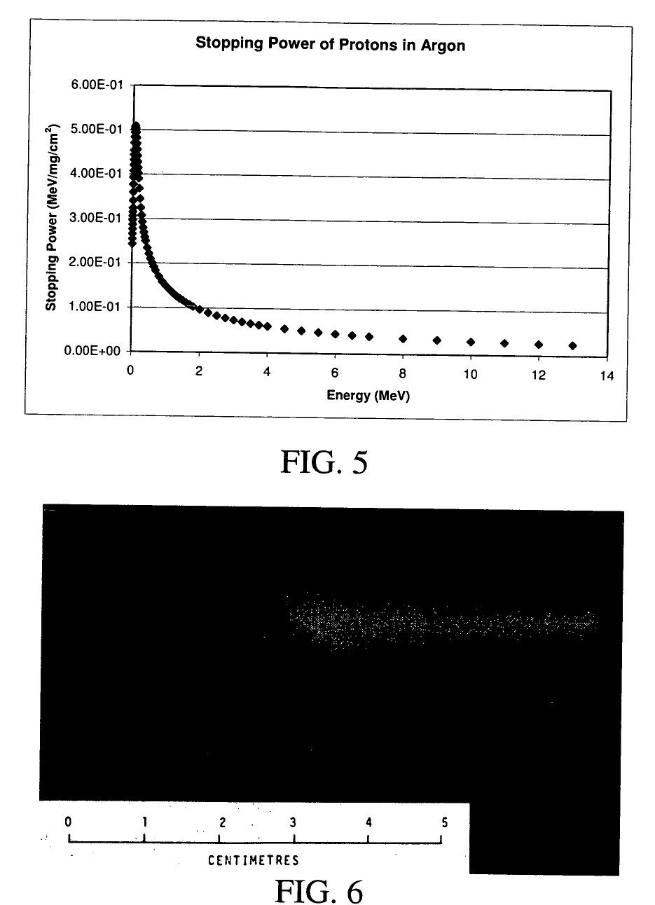

As discussed above, theory suggests that a proton beam incident on a gas target should be primarily forward directed with a slight beam expansion due to scatter, as illustrated in FIG. 3.1, and this effect should not be dependent on the number of protons incident on the target gas.

Accelerators, for example cyclotrons, generate charged particles of various energies which may then be used in a number of applications including, for example, the production of radioisotopes for biomedical research and diagnostic medicine. The production cross sections of these radioisotopes are highly dependent upon the energy of the beam. Thus having an accurate measure of the energy of the particle beam is very important for improving the yield from the production processes. As used herein, the term cyclotron refers to any accelerator capable of producing a beam of charged particles. Further, although the examples provided utilize a proton beam, these examples are not limiting and are intended to encompass other charged particle beams utilizing, for example, deuteron or alpha particles.

Cyclotron manufacturers usually calibrate the energy of the beam (internally or extracted) through Rutherford scattering experiments. However these experiments require sophisticated equipment and operational conditions that are not similar to the conditions under which the cyclotron would be used. In addition there are circumstances under which the expected beam energy will be different than expected due but not limited to:
Different stripper foil thickness on negative ion machines,
Wrong radius of extraction,
Wrong angle of incidence for extractor (azimuthal), and/or
Wrong angle of beam emergence from the cyclotron to the target.

Thus a simple, inexpensive and repeatable means of measuring the energy of the particle beams will be extremely useful in these calibrations. The invention described below requires only 1) foils of the appropriate material, 2) a timing device of sufficient accuracy (e.g., ±1 second) and a gamma-ray spectrometer calibrated for energy and efficacy.

The production of a radioisotope can be expressed by Formula 5:

$$A = \frac{ⅆ N}{ⅆ t} = nI σ ( 1 - {ⅇ}^{- λ t} ) \qquad [ 5 ]$$

where:
A is the radioactivity produced (disintegration per second),
I is the proton flux (particles per second),
n is the number of target nuclei (per cm²),
σ is the cross section (cm²)
(1-e^{-λt}) is the saturation factor (unit less) which takes into consideration the fact that the radioisotopes generated is decaying. There will be a point where the production and decay reach equilibrium.
λ the decay constant (ln2/half-life, per second)
t the time of irradiation in seconds

The production of radioisotopes is, in general, highly energy dependent. By the choice of foil to irradiate one can generate one or more radioisotopes in the foil, simultaneously. If two radioisotopes are generated, and their production cross sections have a different energy dependence, the ratio of the respective amounts of the radioisotopes produced can be used to determine the energy of the beam. Thus, the activity ratio may be expressed by Formula 6:

$$Activity Ratio = \frac{{A}_{1}}{{A}_{2}} = \frac{nI {σ}_{1} ( 1 - {ⅇ}^{- {λ}_{1} t} )}{nI {σ}_{2} ( 1 - {ⅇ}^{- {λ}_{2} t} )} = \frac{{σ}_{1} ( 1 - {ⅇ}^{- {λ}_{1} t} )}{ {σ}_{2} ( 1 - {ⅇ}^{- {λ}_{2} t} )} \qquad [ 6 ]$$

wherein the terms are the same as Formula 5 above and A₁ and A₂ are the radioactivities of isotopes 1 and 2 produced in the foil. From this relationship it can be seen that the only variables in the ratio equation are the cross sections (energy dependent) and the time of irradiation.

The radioactivities may be measured using a calibrated gamma-ray spectrometer or equivalent device (i.e., a system or device that can determine the quantity of each radioisotope produced with sufficient precision). The n term must reflect the abundance of the corresponding target nuclei in the foil.

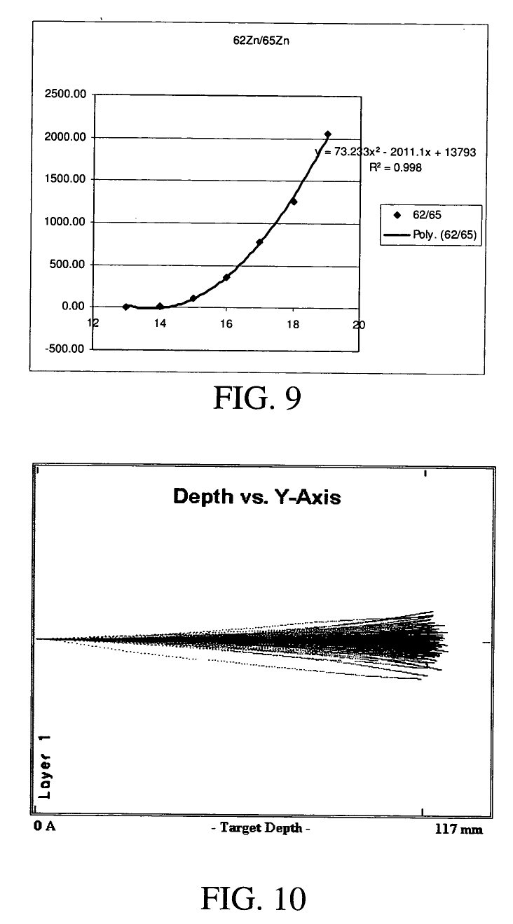

An example of such a ratio is for the production of ⁶³Zn and ⁶⁵Zn from copper foils of natural abundance is illustrated in FIG. 9. The curve illustrated in FIG. 9 was generated based on the IAEA cross section data for the reactions ^{nat}Cu(p,n)⁶⁵Zn and ^{nat}Cu(p,2n)⁶³Zn. One can readily see that by bombarding a foil with protons of unknown energy between the values of 14 and 20 MeV and measuring the induced amounts of ⁶³Zn and ⁶⁵Zn, their ratio will provide an accurate measure of the incident proton energy. There is no need for an independent measure of the beam current of the size/amount of target material. The irradiation time is only important for calculating the saturation factor, thus the degree of accuracy will depend upon the relationship of the half-life to actual irradiation time, thereby reducing the need for precision in time measurement.

This method may be adapted for a range of particles and beam energies by the selection of appropriate foil material(s) and thereby determine the range of radionuclides that can be generated by the charged particle beam. As will be appreciated by those skilled in the art, appropriate foil material(s) may be selected to provide an appropriate pair of reactions over a range of energies required for evaluating an accelerator of interest. Accordingly, this method is not be limited to proton beams or cyclotrons.

A Monte Carlo based program, SRIM (the Stopping and Ranges of Ions in Matter), was employed in order to model the theoretical attenuation and scattering of a beam of protons entering a gas target. As a charged particle passes through a target material it can interact with each target atom along its path. A number of events can occur during interaction ranging from elastic scattering, where the incident particle emerges with the same energy, to ionization of a target electron, to even nuclear reactions. The likelihood of each interaction has a probability function for that event. The usefulness of the Monte Carlo technique arises from its ability to randomly select which event will occur based on each interaction's probability function. Each particle is tracked along its path until it is stopped in either the gas or the target chamber walls.

SRIM allows the user to choose the number and type of ions incident on the target, as well as the target material, state, and pressure. The program will then output, both graphically and in text lists, the x, y and z coordinates of each interaction of a proton with a gas molecule as well as the energy with which the proton interacts. FIG. 10 illustrates such a graphical output from SRIM depicting 12.5 MeV H ions incident on Argon gas at 1551 kPa (225 psi). The y-axis illustrates the spatial distribution. The proton beam enters the target gas from the left.

In order to determine the theoretical energy with which a beam of protons should be interacting with our experimental target body walls, a program was written using Microsoft Visual Basic™. This program takes the SRIM text file as input, which consists of lists of the x, y, and z coordinates and the energy of the proton at each of these positions and then calculates the magnitude of the vector between the x and y coordinates of each interaction by Formula 7:
V̅=\sqrt{x²+y²} [7]

By setting this vector equal to the radius of the target's inner chamber, for example, r=7.5 mm, we can pick out the energy of the interacting proton at that radius. These energies are then averaged over intervals along the length of the target, corresponding to the experimental portion of this project.

For this model argon gas was used at 690 kPa (100 psi), 1551 kPa (225 psi) and 2068 kPa (300 psi). These pressures were chosen to mimic a thin, borderline thick and thick target. A gas target is said to be thick if the number of gas molecules within the beam's path is high enough to reduce the incident particle's energy to below the threshold energy of the reaction in question. Conversely, a thin target results from a lack of sufficient amounts of gas molecules to reduce the beam energy to below this threshold. A borderline thick target, hence, would allow the protons to just reach the end of the target with the reaction's threshold energy. A more detailed discussion of cross-sections and threshold energies can be found above.

At low beam currents this model should accurately describe the proton beams interaction with the target gas, however, because the SRIM Monte Carlo program is not designed to model thermal effects the model is expected to fail with increased beam current. This project was aimed at studying this deviation from the low current baseline.

In order to qualitatively view that the theoretical model above does not adequately describe what is taking place within our experimental gas target we employed autoradiographic imaging. The autoradiography system at the Brain Research Center at The University of British Columbia Hospital is a Cyclone® storage phosphor system consisting of a set of phosphor crystal plates and a laser scanner. Radiographic images are acquired through a storage phosphor process, as illustrated in FIG. 11. Radioactive samples are placed onto the Europium doped crystal plates (BaFBr:Eu²⁺). As the sample activity decays, the particles emitted ionize the Eu²⁺ to Eu³⁺. This liberates electrons to the conduction band of the crystal. Once the radioactive sample is removed, exposing the plates to red laser light at 633 nm will cause the Europium to emit a photon at 390 nm in order to return to its ground state. These photons are then collected and plotted by the scanner and the OptiQuant™ image analysis software, in order to recreate an image of where the activity was previously placed.

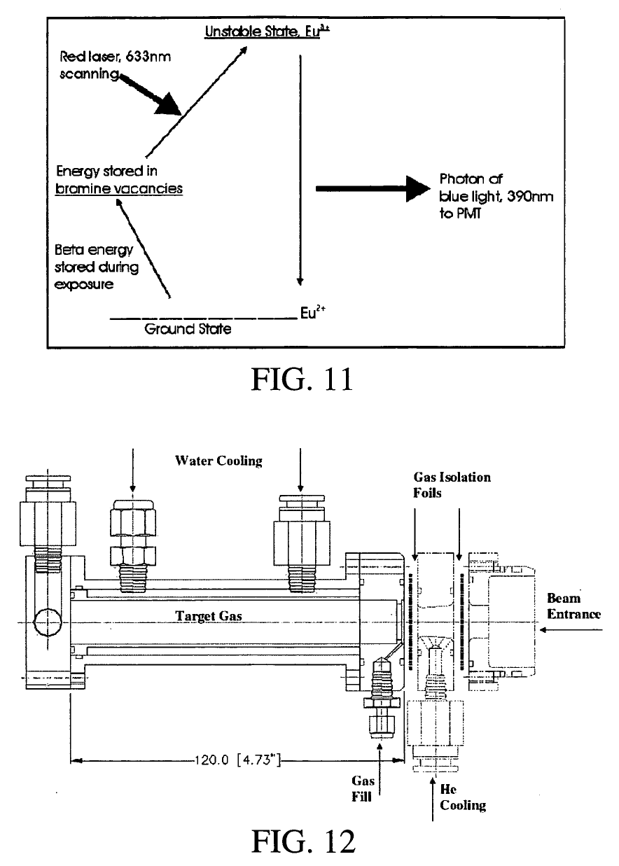

In order to indirectly image the protons interacting with the inner wall of our experimental target we have imaged the radioactivity produced in a copper foil lining by the scattered protons. The production of activity in metal foils has previously been described above. A schematic drawing of the experimental target is provided in FIG. 12.

From the theory discussed above, we can see that we should be able to calculate the energy of the particles, which are scattered to the target body walls, by measuring the radioactivity produced in a foil liner. This radioactivity could then be used to simply calculate the cross-section that would be needed to produce such radioactivity and from the cross-section we could determine the energy of the particle directly from the excitation function for that reaction. To do this, however, we would need accurate knowledge of the flux of the particle beam. That is, we would need to know the exact number of particles being scattered to the walls. This is a difficult question to answer, which led us to develop a method for overcoming this obstacle using the stacked foil method for creating a calibration curve reflecting the ratio of radioactivities of the two simultaneously produced radioisotopes versus the energy drop through each foil. This calibration curve could then be used to determine the proton energy from the activity produced in a foil lining by a known period of irradiation of the foils by the energy beam.

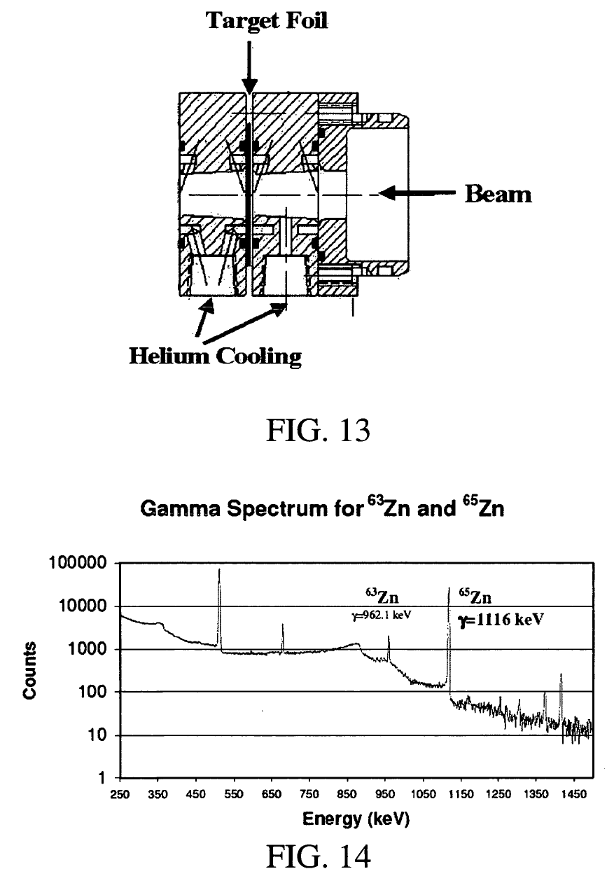

To generate our calibration curve, a stack of 15 copper foils, each 0.025 mm thick, was placed perpendicular to the proton beam. A schematic of the target holder can be seen in FIG. 13. As the proton beam passes through each subsequent foil its energy is decreased by an amount that can be estimated by stopping range tables, as provided by the SRIM computer program or other modeling program or calibration test data. These ranges are dependent on the stopping power, dE/dx, of the copper foils. The results achieved using a 12.8 MeV beam through this stack of copper foils can be seen below in TABLE 3.

TABLE 3

| Foil | Energy of Proton beam | |
|---|---|---|
| number | entering the foil (MeV) | ΔE (MeV) |
| 1 | 12.8 | 0.6 |
| 2 | 12.2 | 0.5 |
| 3 | 11.7 | 0.6 |
| 4 | 11.1 | 0.6 |
| 5 | 10.5 | 0.6 |
| 6 | 9.9 | 0.6 |
| 7 | 9.2 | 0.7 |
| 8 | 8.5 | 0.7 |
| 9 | 7.8 | 0.7 |
| 10 | 7.0 | 0.8 |
| 11 | 6.1 | 0.9 |
| 12 | 5.2 | 0.9 |
| 13 | 4.2 | 1.0 |
| 14 | 2.9 | 1.8 |
| 15 | 1.1 | 1.1 - |
| | | threshold energy |

The resolution of the calibration is limited by the thickness of the foils. As the protons through a single foil, their energy decreases by a finite amount. This amount increases with foil thickness. As a result, each foil actually represents a range of energies, from the protons entrance energy to their exit energy.

Copper has two naturally occurring isotopes, ⁶³Cu and ⁶⁵Cu. Bombardment with 13 MeV protons will produce both ⁶³Zn and ⁶⁵Zn through (p, n) reactions. TABLE 4 list the relevant parameters for these reactions.

TABLE 4
^{nat}Cu(p,n)^{63,65}Zn parameters

| | Percent | | | |
|---|---|---|---|---|
| Natural Copper | Abundance | Reaction | Product | Half-life |
| ⁶³Cu | 69.17% | ⁶³Cu(p,n)⁶³Zn | ⁶³Zn | 38.47m |
| ⁶⁵Cu | 30.83% | ⁶⁵Cu(p,n)⁶⁵Zn | ⁶⁵Zn | 244.06d |

The radioactivity of each radioisotope was determined with the use of a high purity germanium detector (HPGe). FIG. 14 shows a sample gamma spectrum of one of the irradiated copper foils. The peaks used in the calculations, labeled at 962.1 keV and 1116 keV, correspond to the decay of ⁶³Zn and ⁶⁵Zn respectively. All unlabeled peaks are also accounted for by the known gamma-rays of the two isotopes. The large peak at 670 keV is from the decay of ⁶³Zn. The baseline is due to photons, with a continuum of energies, which arise during Compton interactions. The peak at 511 keV is due to the annihilation photons which arise as a result of positron decay of the two isotopes and pair production in the detector crystal. The “jitter” is due to statistical fluctuations in counts at low total counts.

The HPGe detector used in this project, as well as an explanation of the efficiency and energy calibrations performed, is detailed below. Also known as intrinsic germanium detectors, these semiconductor detectors are replacing their lithium-drifted counterparts due to their ability to be stored at room temperature. One appealing characteristic of germanium detectors is their improved energy resolution that lends itself well to applications involving gamma ray spectrometry of complex energy spectra by allowing for discrimination of closely spaced photopeaks.

The detector system used for this project consisted of an Ortec coaxial HPGe detector with a built-in preamplifier in an upright position and is surrounded by custom made shielding. The electronics used included an Ortec amplifier, model 572, an Ortec high voltage power supply, model 459, both set in a B. L. Packer Co. (blp) nuclear instrumentation modules (NIM) bin, model NB-10. The multi-channel analyzer (MCA) is a Nucleus™ personal computer analyzer (PCA-II) computer plug-in board and the data is collected and displayed using Nucleus Inc. PCA-II software.

Prior to use, an energy calibration was performed and an absolute efficiency versus energy curve was constructed. Both were executed using a multi-line calibrated point source consisting of both ¹²⁵Sb (t_{1/2}=2.76y), and ¹⁵⁴Eu(t_{1/2}=8.59y). This source has many peaks over our range of interest, from approximately 100 keV to 1500 keV. The Nucleus software has a built-in energy calibration option, which allows the user to assign energies to several channels and it then interpolates the energies in between. The absolute efficiency was calculated using the following equation;

$${ɛ}_{abs} = \frac{Number of pulses recorded}{Number of quanta emitted by the source}$$

wherein

ε_{abs} is the absolute efficiency;

The number of pulses recorded is the number of counts stored for each peak by the Nucleus software; and

the number of quanta emitted by the source is the radioactivity, in Bequerels (1 Bq=1 disintegration per second), multiplied by the count time in seconds. To obtain the number of quanta emitted by the source, the present radioactivity of each isotope must be calculated to account for decay using the equation:
A=A₀e^{-λt}
wherein:
A is the present radioactivity of the isotope;
A₀ is the calibrated activity as of the initial or a previous calibration;
λ is the decay constant and is equal to ln2/t_{1/2}; and
t is the decay time.

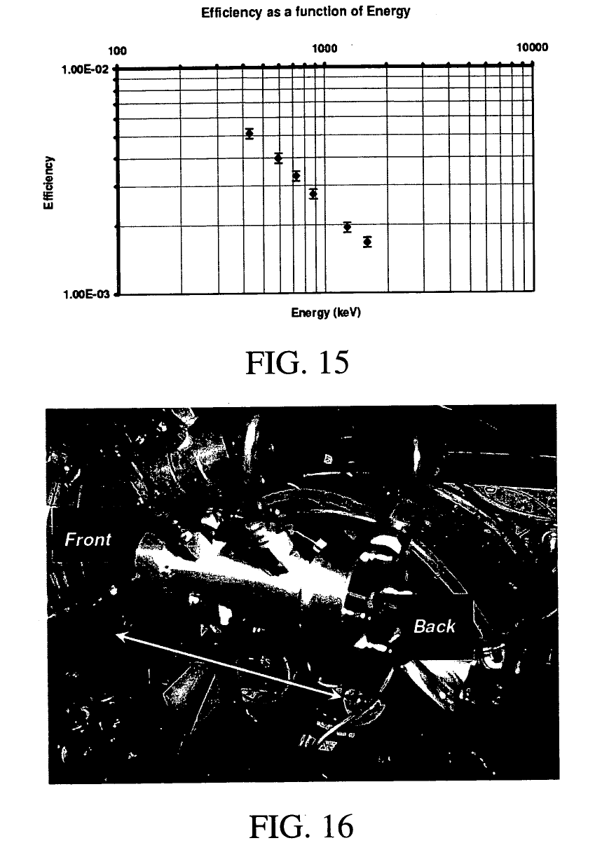

The absolute efficiencies were calculated for three different detector-source distances; one each at 4 cm, 17.5 cm and 60 cm from the detector surface. These geometries were chosen to provide acceptable numbers of counts observed by the detector without obtaining too much dead time or coincidence summing. The log(ε_{abs}) versus log(Energy) curve for the 4 cm distance geometry can be found in FIG. 15.

The number of counts from each peak is related to the activity of the isotope by Formula 8:

$$A = \frac{ⅆ N}{ⅆ t} = \frac{n}{b ɛ t} \qquad [ 8 ]$$

wherein:
dN/dt is the activity of the isotope in disintegrations per second
n is the number of counts
b is the branching ratio for that peak,
ε is the efficiency of the detector at that energy and geometry.
and t is the detector counting time, in seconds.

As the energy of the beam decreases, the activity produced in the foils will vary due to the changing cross-section of the two reactions ⁶³Cu(p,n)⁶³Zn and ⁶⁵Cu(p,n)⁶⁵Zn. The activity of each isotope produced during bombardment can be calculated using Formula 9:

$$R = \frac{ⅆ N}{ⅆ t} = nI σ ( 1 - {ⅇ}^{- λ t} ) . \qquad [ 9 ]$$

Because the calibration curve made use of the ratio of the activities for each isotope, error incurred through fluctuations in beam current is factored out, leaving the only opportunity for experimental error in irradiation times. Also, using an experimental calibration curve instead of one calculated from theory eliminates the uncertainty in the literature values for the cross-sections. If the values for the cross-sections used are those for natural copper the number of target atoms is also eliminated from the ratio since the natural abundances for the two stable isotopes has already been accounted for. The ratio can be seen below where the subscripts 1 and 2 indicate variables corresponding to ⁶³Zn and ⁶⁵Zn, respectively.

$$Activity Ratio = \frac{{A}_{1}}{{A}_{2}} = \frac{nI {σ}_{1} ( 1 - {ⅇ}^{- {λ}_{1} t} )}{nI {σ}_{2} ( 1 - {ⅇ}^{- {λ}_{2} t} )} = \frac{{σ}_{1} ( 1 - {ⅇ}^{- {λ}_{1} t} )}{ {σ}_{2} ( 1 - {ⅇ}^{- {λ}_{2} t} )}$$

The experimental target, which generally corresponds to the schematic in illustrated in FIG. 13, is shown in FIG. 16. A rectangular copper foil lining, with dimensions of 12 cm by 5 cm, was inserted through the rear and the back panel was lined with another small circular foil. The chamber was then sealed and filled with Argon gas. The target was then irradiated for 5 minutes and the radioactivity is allowed to decay for a sufficient amount of time in order to minimize personal radiation dose exposure. These decay times are 1 h for each 1 μA run, 3 h for each 10 μA run and 4 h for each 20 μA run. This procedure was then repeated for each of the beam currents and pressures found in TABLE 5.

TABLE 5
Irradiation parameters

| Initial Target | | |
|---|---|---|
| Pressure | Beam Current | Irradiation Time |
| (kPa ± 20 kPa) | (μA ± 0.5 μA) | (minutes ± 2 seconds) |
| 690 | 1, 10 | 5 |
| 1551 | 1, 10, 20 | 5 |
| 2068 | 1, 10, 20 | 5 |

After irradiation, the Argon gas was then released to a sealed bag to avoid possible air contamination with radioactive gas. The foil liner was then removed from the target body, unrolled and cut into 12 equally sized pieces. The activity produced in each piece, including the rear liner foil, was then determined using the HPGe detector, and the radioactivity of each isotope is calculated as described above. Once the ratio of the activities of the two isotopes for each section of the foil liner was obtained, it was calibration curve was consulted to determine the corresponding proton energy.

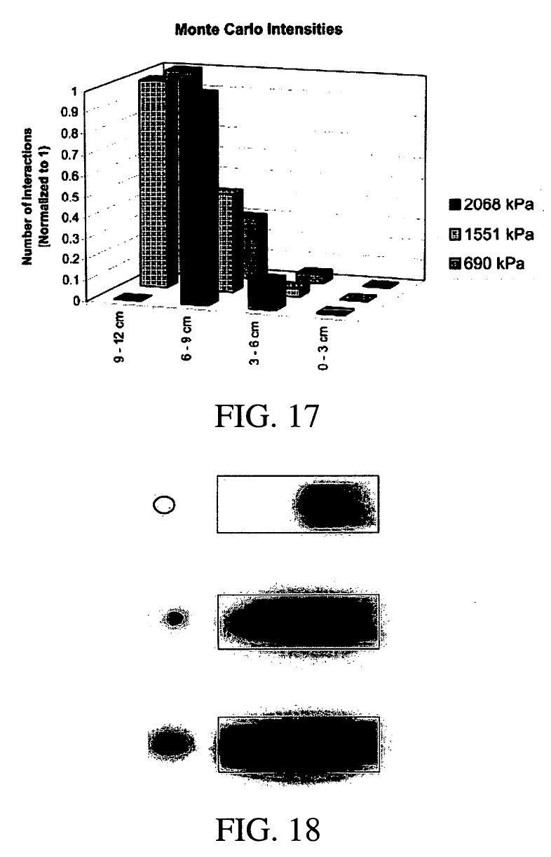

The results for the Monte Carlo model can be found below in TABLE 6 wherein the top number in each cell is the average energy of the protons interacting with the target body walls. The bottom number is the relative number of proton interactions with the walls in each depth interval. These values have been normalized to the number of interactions determined for the depth having the maximum number of interactions. These intensities are also plotted as a histogram and can be found in FIG. 17.

TABLE 6

Pressure

| Depth | 690 kPa | 1551 kPa | 2068 kPa |
|---|---|---|---|
| 0-3 cm | 11.1 MeV | 9.5 MeV | 9.0 MeV |
| | 0.001 | 0.003 | 0.005 |
| 3-6 cm | 10.1 MeV | 7.5 MeV | 5.0 MeV |
| | 0.043 | 0.039 | 0.139 |
| 6-9 cm | 9.1 MeV | 3.6 MeV | 1.0 MeV |
| | 0.298 | 0.476 | 1 |
| 9-12 cm | 8.0 MeV | 0.5 MeV | — |
| | 1 | 1 | 0 |
| Back of Target | 7.5 MeV | — | — |
| | 0.1424 | 0 | 0 |

The depth intervals correspond to the size of the cut foil pieces in the experimental portion of this project. To correct for the finite spatial distribution of the experimental proton beam the program was run for a target radius of 0.75 cm (1.5 cm diameter target chamber) and then again for a target radius of 0.25 cm. The results for r=0.75 cm and r=0.25 cm were averaged in order to simulate a beam spot size of 1 cm diameter. These numbers were calculated based on 2,000 incident protons; 1000 originating from the center and 1000 at 0.5 cm from the center (i.e., 0.25 cm in from the target wall, hence the 0.25 cm radius calculations). As a comparison, the SRIM program was run using 10,000 incident protons at 2068 kPa and resulted in a variation in one decimal place of the energy. The error quoted in the SRIM documentation is, on average, 7%. Autoradiographic images of copper foil lining irradiated through argon gas at an initial pressure of 2068 kPa (300 psi) at beam currents of, from top to bottom, 1 μA, 10 μA, and 20 μA, are illustrated in FIG. 17.

The copper foil dimensions were 5 cm by 12 cm with the foil lining the back being 1.5 cm in diameter. This rectangular copper foil was rolled into a cylinder and then placed into the cylindrical target body whereby the foil was oriented so that the central axis of the rectangle was placed along the top of the target while the outer edges met at the bottom of the target. A separate circular foil was used to line the back of the target body.

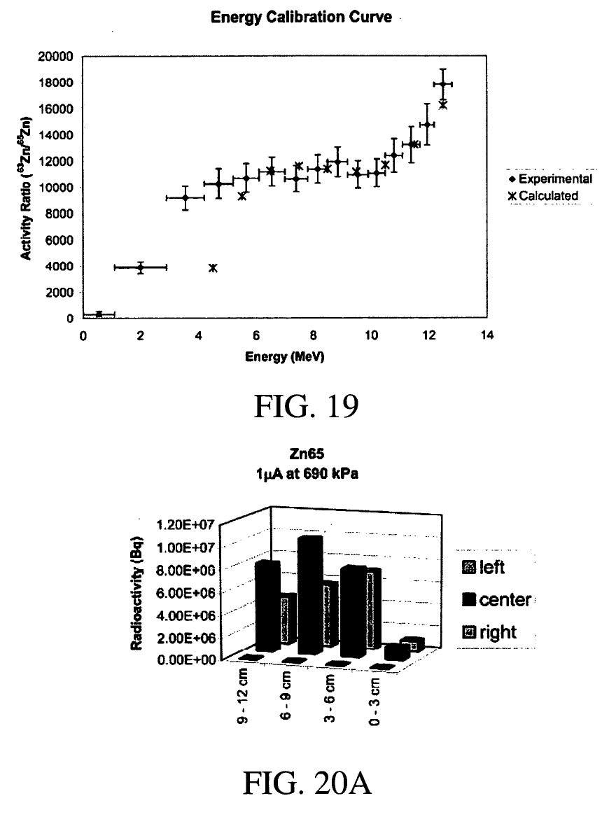

As illustrated in FIG. 17, as the beam current progressed from 1 to 20 μA, there was a marked increase in the proton penetration which has been attributed to the corresponding density reduction in the gas at the higher currents. The resulting experimental calibration curve is illustrated in FIG. 19 in conjunction with corresponding theoretically calculated points which were determined using the activity ratio expression discussed above and the published cross-sections. Each point on the experimental curve corresponds to one foil in the stack of 15 Copper foils with the x-error bars corresponding to the energy drop through each foil. The y-error was calculated with consideration of the errors associated with irradiation time, counting statistics and geometric efficiency. The maximum variation in irradiation time was taken to be 2 seconds, giving an associated error of 1.75%.

The uncertainty in the counting statistics was taken to be the square root of the number of counts recorded by the Germanium detector. Because the error associated with the calibration source used in calculating the efficiency curve was not known, a maximum uncertainty of 5% was assumed. This assumption is believed to be more than sufficient to compensate for the uncertainty associated with the counting statistics (<2%) during the calibration. The deviation between experimental and the calculated values in the lower portion of the curve is attributed to energy straggling resulting from the statistical nature of charged particle energy loss. As a beam of particles pass through a finite thickness of absorber they are no longer monoenergetic, but have a distribution of energies about the predicted energy. Thus, while the published cross-sections used in establishing the calculated curve drop to zero around 4 MeV, the proton beam still contains particles above and below this value. Accordingly, even though the average proton energy may be below the threshold for the nuclear reaction there are still protons present with sufficient energy to overcome this threshold.

The results for the each pressure can be found in TABLES 7-9 in which the results are configured to correspond to entry of the proton beam from the right hand side of the table. The grid represents the cut foil pieces and the box to the left is the liner for the back of the target. The top data set, for 1 μA, is marked with the corresponding depth intervals according to the cut copper foil lining. All other data sets have the same intervals. Within each box, representing one cut foil segments, are three numbers. The top number, in bold lettering, is the energy range according to the calibration curve, in MeV. The middle number is the calculated radioactivity ratio for the two isotopes. The final number is the radioactivity for Zinc-65. The radioactivity has been normalized to the measured radioactivity for the cut foil segment having the highest radioactivity level for a given run.

TABLE 7

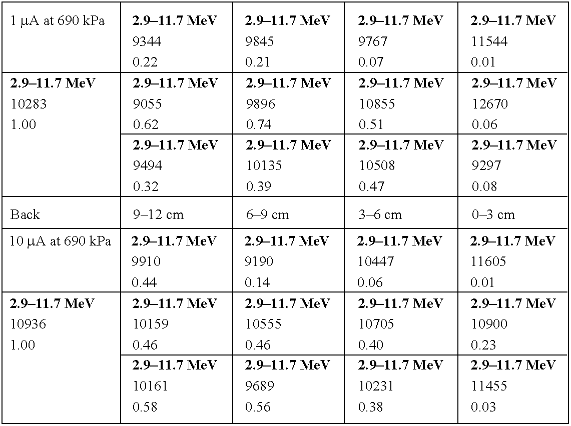

TABLE 8

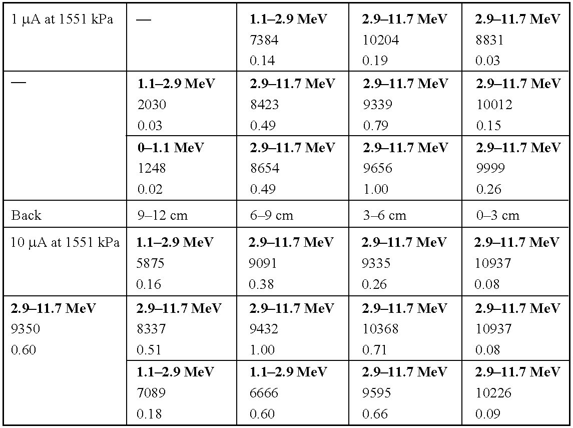

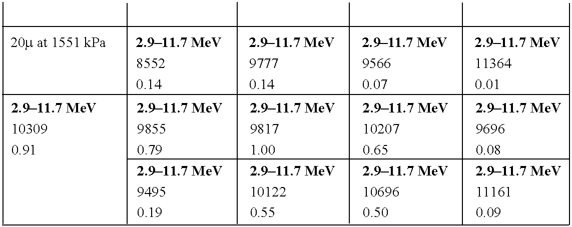

TABLE 9

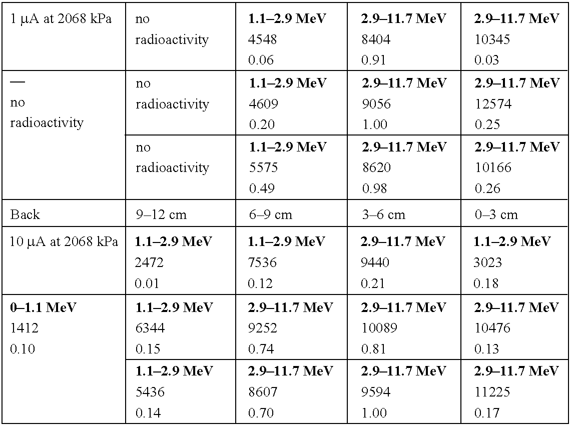

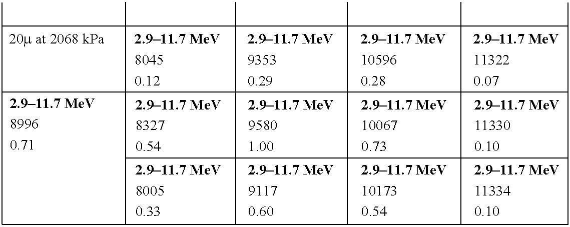

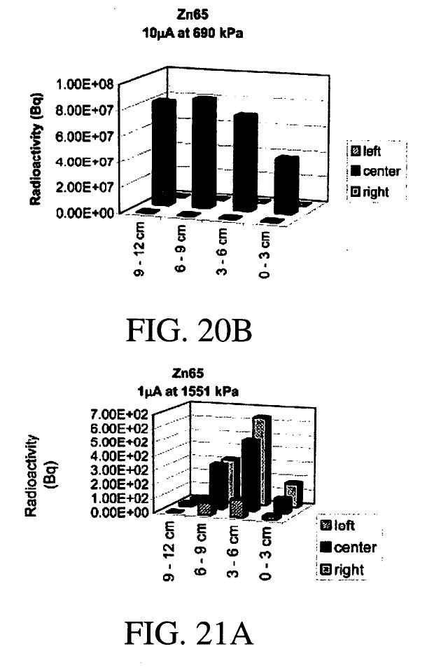

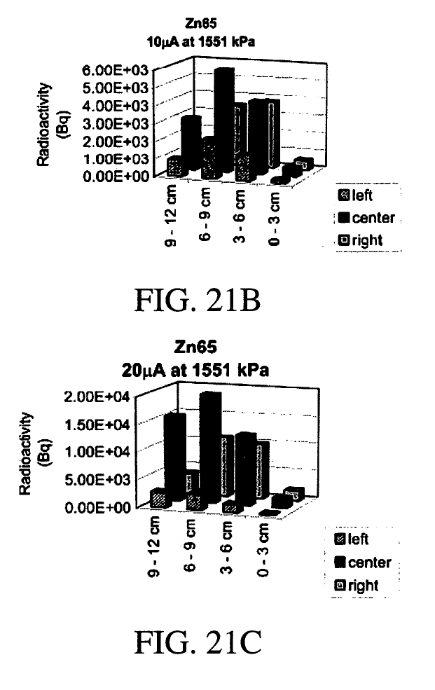

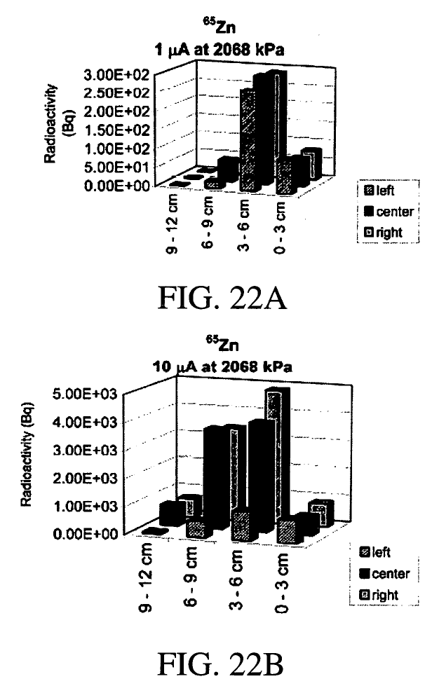

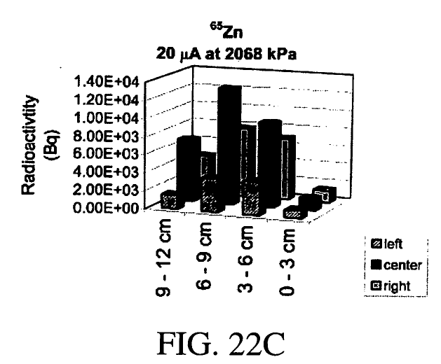

Histograms of the radioactivity of Zinc-65 in each foil segments have been plotted and can be found in FIGS. 20A-22C. It should be noted that the general trend seen in the Zinc-65 data sets was the same for the Zinc-63 data sets. The asymmetry of beam deposition in the foil lining can be seen in these figures. The lower activities count in the right hand side of the foil are attributed to a slight overlap of the left side of the foil.

In the data sets presented in TABLES 7-9, there is a clear increase in particle energy and induced radioactivity in the foil lining towards the end of the target associated with increasing beam current. A corresponding increase in induced radioactivity is seen in the walls of the target, particularly along the top of the chamber. These observations generally agree with the results found in the autoradiographic images as well as the light emission photographs taken by Heselius et al and reproduced in FIG. 6. Although some have questioned whether or not the light emission photographs truly reflect the beam profile due to the fact that the image is of the photons emitted by the gas molecules during interaction with a charged particle and are not, therefore, an image of the ion beam itself. The experimental results obtained in developing this method, however, support the hypothesis that the beam profile is accurately reflected in those photographs.

Further, questions have been raised as to whether or not the scatter profile of an ion beam into a gas target can be predicted with sufficient accuracy using Monte Carlo simulations. Again, our results indicate that at low beam current the Monte Carlo results reflect the scatter profile reasonably well, however with increasing beam current the processes occurring within a gas target during irradiation are far more complex than those that are encompassed by the assumptions made for a standard Monte Carlo program. Indeed, the results for the Monte Carlo calculations tended to differ, in some instances substantially, from those resulting from the analysis of the foil-lined target at 10 and 20 μA, as seen in FIGS. 20B, 21B, 21C, 22B and 22C. As an example, the Monte Carlo results would indicate that at 2068 kPa the proton beam would only reach about 9 cm depth. The results from the experimental energy profile, however, indicate that the proton beam depth will increase with increasing beam current and at 20 μA can achieve full penetration through the gas.

Because of the similar ranges of protons at the tested energies in both Argon and Nitrogen gas, it is possible to compare the results obtained with those reported for the production of Carbon-11 from Nitrogen gas. The proton range, according to SRIM, of 12.5 MeV protons in 1 atm of Nitrogen is 1.65 m, while 12.5 MeV protons incident on 1 atm of Argon is given as 1.56 m. TABLE 10 gives the percent yield with respect to the theoretical yield for several beam currents as given by Buckley et al. for a conical chamber (rather than the cylindrical one used in these experiments) on the TR13 at TRIUMF using a N₂/H₂ gas mixture with 10% H₂, an irradiation time of 2 to 3 minutes and at a gas pressure of 2068 kPa (300 psi).

TABLE 10

| Beam Current (μA) | Yield (% theoretical) |
|---|---|
| 5 | 100 |
| 10 | 100 |
| 20 | 89 |
| 30 | 61 |

From FIG. 7, we can see that the threshold energy for the production of Carbon-11 from Nitrogen is approximately 4 MeV. From the results for the 2068 kPa experiments, given in TABLE 10, at 10 μA the energy of the protons reaching the back of the target is between 0 and 1.1 MeV. Therefore, this still qualified as a thick target for this reaction as reflected in the near 100% yields that can be obtained. This also suggests that the loss of beam due to scattering to the walls has a relatively minor effect on production at the beam currents. Once the beam current is increased to 20 μA, however, the energy of the protons reaching the back of the target is between 2.9 and 11.7 MeV. Because the target does not operated as a thick target at these energies, the yield is reduced correspondingly and may be lower than theoretically expected. This observation may be even more dramatic at even higher beam currents, for example, 30 λA, at which point the yield drops to about 61% of the theoretical yield.

as detailed above, both an increase in particle penetration due to density reduction and loss of protons due to scattering into the target chamber walls has been noted as possible sources of reduced radioisotope production yields. In order to compare the amount of protons lost to the walls of the target through scatter to those lost to the back of the target by increased penetration from density reduction we have summed the Zinc-65 activities produced in each foil section to obtain the radioactivity in the entire copper foil lining and from this calculated the percent total activity (i.e., percentage of lost beam) in the back liner foil and wall liner foil. This total activity is related to the amount of beam lost. The percentages for the 690 kPa, 1551 kPa and 2068 kPa experiments can be found in TABLE 11.

For the 1 μA runs for both 1551 kPa and 2068 kPa 100% of the activity produced was in the walls. From this we can see that the most significant amount of beam lost is to the outer walls of the target. However, this is simply the percentages of lost beam and cannot be correlated to the amount of total beam without knowing the total number of protons incident on the target. It is also difficult to relate this to production yields without knowing the energy of the scattered protons. Since the threshold for producing Zinc-65 is around 2.5 MeV many of these protons may be below the 4 MeV threshold for Carbon-11 production. For example, the study preformed by Buckley et al reported approximately 100% yield at 10 μA, suggesting that the portion of the beam being lost to scatter to the walls is insignificant in either the number of protons which are scattered or the energy of the scattered protons to affect the total yield.

TABLE 11

| | | | Percent |
|---|---|---|---|
| Pressure (kPa) | Beam Current (μA) | Foil Position | Total Activity (%) |
| 690 | 1 | Walls | 79 |
| | | Back | 21 |
| | 10 | Walls | 78 |
| | | Back | 22 |
| 1551 | 10 | Walls | 89 |
| | | Back | 11 |
| | 20 | Walls | 82 |
| | | Back | 18 |
| 2068 | 10 | Walls | 98 |
| | | Back | 2 |
| | 20 | Walls | 87 |
| | | Back | 13 |

The total Zinc-65 radioactivity for the lining of the walls and back has been used to compare the increase in beam lost to wall interactions with increased beam current. The total activity for each experiment has been divided by the respective beam current to obtain the amount of radioactivity produced per μA. This was then divided by the radioactivity produced at 1 μA in order to observe the number of times increase. The numbers can be seen in TABLE 12 which reflects the factor by which the radioactivity produced in a foil lining increases per μA. Ideally, we would like to improve the ability of the target chamber to accommodate irradiation of the gas with the highest beam current available. As discussed above, however, increased beam current results in increased penetration and scatter to the walls, particularly to the top of the target chamber. One possible approach for reducing this loss from scatter may be a target chamber with a water-drop cross-section shape. This would accommodate the larger amount of radioactivity produced in the foil lining at the upper portion of the chamber as seen in FIGS. 20-22.

TABLE 12

| | | Number of |
|---|---|---|
| Pressure (kPa) | Beam Current (μA) | times increase over a 1 μA run |
| 690 | 1 | 1.0 |
| | 10 | 6.3 |
| 1551 | 1 | 1.0 |
| | 10 | 1.3 |
| | 20 | 2.2 |
| 2068 | 1 | 1.0 |
| | 10 | 1.8 |
| | 20 | 2.9 |

The development of a Monte Carlo program having improved compensation for the effects of thermal convection and heat transfer on the proton path and energy within a gas target, would be beneficial to tracking the reaction cross-sections and improving production capabilities. With both autoradiography and the foil lined target experiments we were able to demonstrate the increase of pressure and particle penetration within a gas target with increasing beam current. Although the Monte Carlo model for proton scattering corresponded reasonably well to the low beam current experiments, as the beam current increased the degree of correspondence was reduced to a point where the model was of little use for determining the beam profile in the target. As noted above, however, a Monte Carlo model for particle penetration that more accurately correction for density variations associated with higher beam currents and the resultant heating would expand the regime under which modeling may be used with sufficient accuracy.

Although a calibrated gamma-spectrometer which can detect the signature gamma rays emanating from the foils and clearly identify the radioisotopes is preferred, such systems may not be readily available at all sites. Accordingly, other means for monitoring the decay of the radioisotopes may be utilized including, for example, an ionization chamber. In such an instance, the irradiated foil can be measured for half-life and get the two components by measuring the effective half-life of the irradiated foil and then backing out the two half-lives of interest in order to determine the relative amount of each isotope present in the foil. Once this ratio is determined the energy of the particle beam can be determined from the calibration curve.

One consideration in such a method is the need to normalize the measurements to account for the different responses associated with the two radioisotopes as a result of the energy dependence of the radiation detector's counting efficiency. With a single isotope one can correct for the counting efficiency of one of its gamma rays at a discrete energy. Because the two isotopes will have characteristic gammas at different energies, the detector's ability to count these gammas (i.e., accurately determine the “response”) in a single detector setting may be skewed towards one of the radioisotopes. Accordingly, an adjustment factor, essentially be an efficiency correction factor, would need to be utilized to correlate the measurements for the two energies of interest.

This adjustment factor can be determined experimentally by correlating the measurements obtained from an ionization chamber with those obtained from a calibrated gamma-spectrometer and/or theoretical results based on the known system variables. As long as the ionization chamber utilized is sufficiently sensitive to provide a reasonable response, i.e., a high count rate for both gammas of interest, the results would be sufficiently accurate to monitor the beam energy.

Multiple radioisotopes may complicate such measurements but, for example, ⁶³Zn/⁶⁵Zn radioisotopes generated at relatively low beam energies should still provide satisfactory results. In situations where more than two radioisotopes are present, the reading may be delayed to reduce the contribution of the shorter-lived radioisotope. For example, with ⁶²Zn/^{63 Zn/}⁶⁵Zn, the ⁶³Zn (38 min) could be allowed to decay to a point where the ⁶²Zn/⁶⁵Zn (9 h and 244 d, respectively) radioisotopes are the dominant species. Accordingly, it is expected that the method utilizing copper foil will provide satisfactory results for energies in the range of about 10 MeV to 18 MeV and perhaps a bit higher.

We claim:

1. A method of determining particle beam energy comprising:
configuring a plurality of target foils in a stacked configuration;
irradiating the target foils with a particle beam, thereby simultaneously generating two isotopes;
monitoring the decay of the two isotopes to obtain a relative radioactivity value; and
correlating the relative radioactivity value to a known particle beam energy.

2. The method of determining particle beam energy according to claim 1, further comprising:
providing an attenuating material between an adjacent pair of target foils.

3. The method of determining particle beam energy according to claim 2, further comprising:
providing an attenuating material between each adjacent pair of target foils.

4. The method of determining particle beam energy according to claim 1, wherein:
the plurality of foils are sufficient to reduce the average beam energy to less than 2 MeV at a surface of a last foil.

5. The method of determining particle beam energy according to claim 4, wherein:
the plurality of foils includes at least 10 individual foil layers.

6. The method of determining particle beam energy according to claim 4, wherein:
each foil included in the plurality of foils has a substantially identical thickness.

7. The method of determining particle beam energy according to claim 2, further comprising:
the target foils are copper and the attenuating material is aluminum.

8. The method of determining particle beam energy according to claim 1, wherein:
the target foils are copper and the two isotopes are ⁶³Zn and ⁶⁵Zn.

9. The method of determining particle beam energy according to claim 1, wherein:
the target foils are copper and the two isotopes are ⁶²Zn and ⁶⁵Zn or the target foils are molybdenum and the two isotopes are ⁹⁴Tc and ^{95m}Tc.

10. The method of determining particle beam energy according to claim 1, wherein:
monitoring the decay of the two isotopes to obtain a relative radioactivity value utilizes a high purity germanium detector or an ionization detector.

11. The method of determining particle beam energy according to claim 10, wherein monitoring the decay of the two isotopes to obtain a relative radioactivity value utilizing an ionization detector further comprising.
applying an adjustment factor to a measured radioactivity.

12. The method of determining particle beam energy according to claim 11, further comprising.
determining the adjustment factor for the ionization detector.

13. The method of determining particle beam energy according to claim 10, wherein monitoring the decay of the two isotopes to obtain a relative radioactivity value utilizing an ionization detector further comprising:
deferring the monitoring for a time period sufficient to reduce a quantity of a third radioisotope for improved monitoring of the two radioisotopes.

14. The method of determining particle beam energy according to claim 13, wherein:
the time period is sufficient to reduce an initial quantity of the third radioisotope to a reduced quantity of no more than 5% of the initial quantity.

15. The method of determining particle beam energy according to claim 13, wherein:
the target foils are copper;
third isotope is ⁶³Zn; and
the two isotopes are ⁶²Zn and ⁶⁵Zn.

16. A beam energy test kit comprising:
an irradiation unit including a plurality of target material foils arranged in a carrier; and
a calibration curve specific to a response of the irradiation unit to a beam energy within a target energy range.

17. The beam energy test kit according to claim 16, wherein:
the target material foils are copper; and
the target energy range is 10 to 20 MeV.

18. The beam energy test kit according to claim 16, further comprising:
an adapter for mounting the carrier in a beam path whereby the foils are arranged substantially perpendicular to the beam path.

19. The beam energy test kit according to claim 16, further comprising:
a plurality of adapters for mounting the carrier in plurality of beam paths.
